(19) United States
(12) Patent Application Publication
(10) Pub. No.: US 2003/0052865 A1
(43) Pub. Date: Mar. 20, 2003

(54) Electronic display card

(76) Inventor: Mindy Lee Miller, Greeley, CO (US)

Correspondence Address: HEWLETT-PACKARD COMPANY, Intellectual Property Administration, P.O. Box 272400, Fort Collins, CO, 80527-2400, US

(21) Appl. No.: 09/953,469

(22) Filed: Sep. 14, 2001

(51) Int. Cl. G09G 5/00

(52) U.S. Cl. 345/173

(57) ABSTRACT

The present invention is directed to a system and method for providing a wallet-sized electronic display card for presenting digital information to a user. The display card preferably comprises a touch-sensitive liquid crystal display (LCD) covering a substantial portion of one face of said display card, a memory, a display processor, and a power source. It also preferably incorporates a selector for allowing a user to control the changing of the digital information displayed on the LCD.

### TECHNICAL FIELD

This application relates to color liquid crystal displays (LCD), and more particularly to pocket-sized color LCD devices for displaying electronic information.

### BACKGROUND OF THE INVENTION

The digital age has created many conveniences with regard to data manipulation, storage, and presentation. Digital imaging devices such as cameras and scanners typically extend the convenience of the digital world to everyday life. With the widespread use of computers and the Internet, digital cameras are generally being used to record photos and/or movies which may then be easily communicated to friends, family, customers, potential customers, and the like through the computer and/or Internet. Traditional images from film-cameras may also be converted into digital format with scanners in order to be communicated through the digital medium. However, with all of the advances in electronic technology, there has generally yet to be a solution developed for the age-old problem of not enough room in a wallet for a sufficient number of pictures.

Devices such as handheld computers and digital picture frames usually allow users to load, store, and carry or display digital pictures. However, even the smallest of handheld computers is still typically bigger and bulkier than a credit card or wallet picture. It may not be feasible for a user to carry around a handheld computer in all instances. A wallet, though, is typically found on most individuals. The expense of a handheld computer may also be prohibitive for many people. Some individuals may also not require the computing power of a full handheld computer. These individuals would be spending money on functions and features that they would not ordinarily need, if their goal was to simply display digital pictures.

Digital frames are also generally becoming more prevalent in the market place. Digital frames typically allow users the convenience of displaying a digital photograph without requiring a user to print out the photos and then cut them to wallet size or the size of any other frames. Digital frames are typically available that provide a decorative border surrounding an electronic display generally capable of displaying one or more digital pictures in color. The digital frames generally operate in a manner similar to traditional frames. While the frame typically has a place on a desk, shelf, or counter, it is generally not practical to carry frames around on one's person. Thus, digital frames also do not solve the problems related to the bulk of multiple wallet pictures.

### BRIEF SUMMARY OF THE INVENTION

In consideration of the problems and deficiencies present in the current implementations for carrying pictures in a wallet, it would be desirable to have a card-sized electronic display device capable of storing and displaying digital images and information to a user. The present invention is directed to a system and method which provides a wallet-sized electronic display card for presenting such digital information to a user. The display card is made up of a touch-sensitive color liquid crystal display (LCD) covering a substantial portion of one face of said display card, a memory, a display processor, and a power source. It also incorporates a selector for allowing a user to control the changing of the digital information displayed on the LCD.

### BRIEF DESCRIPTION OF THE DRAWINGS

For a more complete understanding of the present invention, reference is now made to the following descriptions taken in conjunction with the accompanying drawing, in which:

FIG. 1 is a perspective view of a preferred embodiment of the present invention configured with a removable cradle;

FIG. 2 is a perspective view of an alternative embodiment of the present invention configured to communicate using wireless technology;

FIG. 3 is a perspective view of an alternative embodiment of the present invention configured with a removable power source; and

FIG. 4 is a flow chart illustrating steps practiced to implement a preferred embodiment of the present invention.

### DETAILED DESCRIPTION OF THE INVENTION

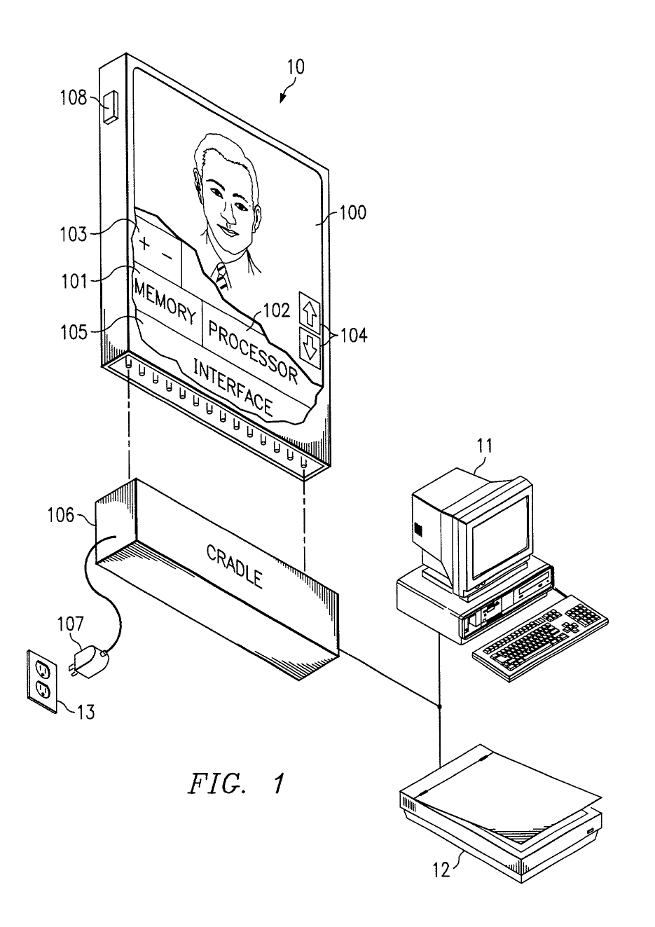

FIG. 1 illustrates a preferred embodiment of the present invention configured as a wallet-sized electronic display card. Card 10 preferably comprises touch-sensitive color liquid crystal display (LCD) 100 for displaying images representing digital information stored on memory 101 or communicated from any one of a number of external devices, such as general purpose computer 11 and/or scanner 12. Display processor 102 preferably uses the digital information to render the graphical images displayed on LCD 100. Card 10 shows a picture displayed on LCD 100. However, it should be noted that any number of different representations of digital information may preferably be rendered and/or manipulated by display processor 102 and displayed on LCD 100. Display processor 102, LCD 100, and the other components and parts of card 10 are preferably supplied by power source 103.

In operation as a photo album, a user can preferably touch LCD 100 to manipulate the functions built into card 10. For example, as a photo album, a user can press on either of picture selectors 104 to advance or go back through the images stored as digital information on memory 101. It should be noted that picture selectors 104, as shown in FIG. 1, are not physical buttons built into card 10, but rather are icons displayed by display processor 102 as a part of a graphical user interface (GUI) for interacting with users. It should be noted, however, that picture selectors 104 may be implemented as physical buttons or switches in alternative embodiments of the present invention. Such physical buttons would preferably take a form similar to mode selector 108, and may be implemented as additional instances of buttons such as mode selector 108. As the user presses either of picture selectors 104, the next or previous picture in the storage queue is processed by display processor 102 and then displayed on LCD 100. In this manner, a user may page through numerous pictures in a very small area.

In order to facilitate communication to obtain new digital information or send the stored digital information to other devices, card 10 also preferably includes interface 105. Interface 105 preferably provides the physical electrical connection point between card 10 and its display processor 102 and any external devices connectable to interface 105. FIG. 1 illustrates cradle 106 preferably connected to general purpose computer 11 and scanner 12. Interface 105 may take any form of electronic connector, such as a pin connector, ribbon connection, optical connection, and the like.

When a user desires to connect to an external device, he or she preferably inserts card 10 into cradle 106 at interface 105. The particular interfacing mechanism will match up to preferably form an electronic connection between card 10 and cradle 106. Once fully connected, card 10 may preferably exchange digital information with either or both of general purpose computer 11 and scanner 12. The information may preferably be stored onto memory 101 or may preferably be directly processed by display processor 102 for display on LCD 100.

It should be noted that in an alternative embodiment of the present invention, cradle 106 also preferably includes AC adapter 107 for plugging into wall electrical plug 13. AC adapter 107 provides recharging to power source 103 through cradle 106. Power may also be provided to power source 103 through cradle 106 by USB ports, or other such similar ports that are capable of providing power through a connection. It should be noted, however, that in preferred embodiments of the present invention it would be more advantageous not to have such a USB port directly on card 10 due to the size requirements for such a port. It would be preferable to have such an alternative embodiment with a USB implementation having its port connected directly into cradle 106. Power source 103 may preferably comprise a removable battery, a rechargeable internal battery, or some combination of both for providing power to card 10.

Card 10 also preferably allows a user to change the digital information displayed on LCD 100 through mode selector 108. Mode selector 108 is shown as a physical button or switch slightly protruding from a side of card 10. Card 10 may preferably come configured to display not only images from digital information, but also may include digital information which executes functional software, such as a calendar and/or a calculator. There may also preferably be other functions executed from other types of digital information stored on memory 101. If a user desires to change from the photo album mode to the calendar mode, the user preferably actuates mode selector 108 which causes the digital information representing the calendar mode to be processed by display processor 102 and then displayed to the user on LCD 100.

It should be noted that in alternative embodiments of the present invention, the alternative functions of digital information may preferably be stored as firmware directly on display processor 102. This embodiment preferably conserves storage space on memory 101 for the user's image digital information.

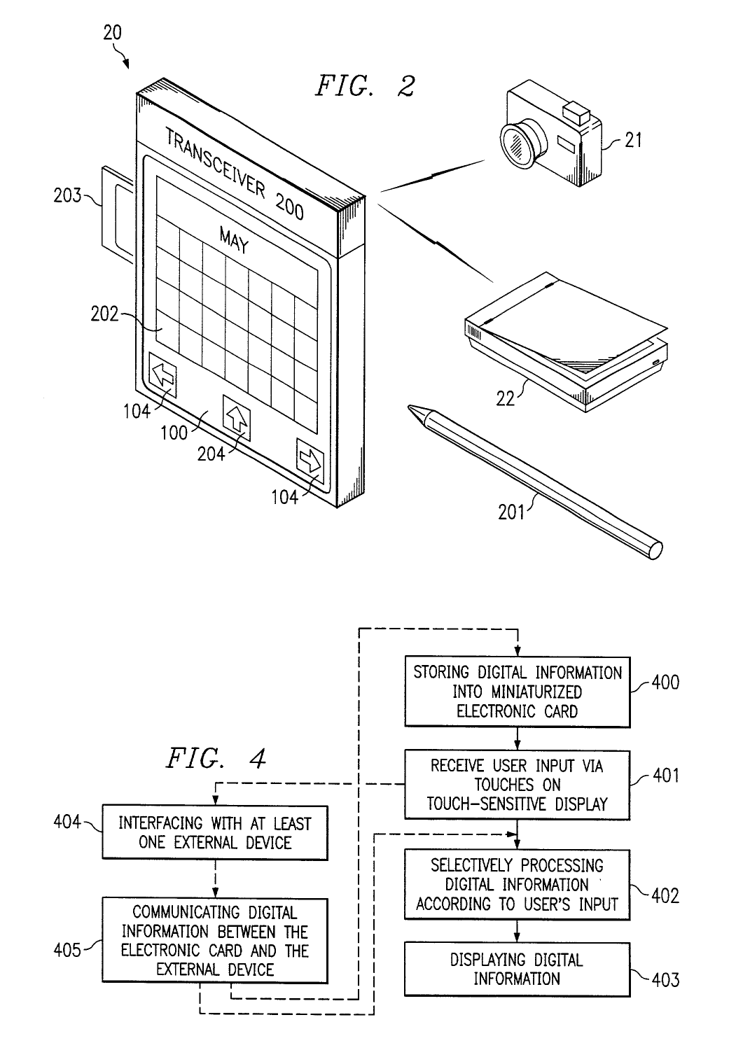

FIG. 2 illustrates an alternative embodiment of the miniaturized electronic card. Miniaturized card 20 also preferably comprises LCD 100 and picture selectors 104. In the alternative embodiment shown in FIG. 2, miniaturized card 20 preferably incorporates wireless capabilities in transceiver 200 disposed as the interface between miniaturized card 20 and any external devices, such as wireless digital camera 21 and wireless compatible scanner 22. Transceiver 200 may preferably be constructed for any type of wireless communication, such as infrared, Bluetooth, HomeRF (TM), IEEE 802.11, and the like. In addition to the wireless capabilities, miniaturized card 20 also incorporates removable storage 203, depicted as a SmartMedia (TM) card. All of the digital data received and/or stored by miniaturized card 20 is preferably stored on removable storage 203.

LCD 100 shows calendar mode 202 displayed. The user may interact with calendar mode 202 using his or her finger or may preferably interact using stylus 201. With stylus 201, the user may preferably tap out or touch certain areas of LCD 100 under control of the GUI run by display processor 102 (FIG. 1).

Transceiver 200 preferably operates as the interface with all compatible external devices. A communication link is preferably established from transceiver 200 to either or both of digital camera 21 and scanner 22. Digital data representing images from digital camera 21 or scanner 22 may preferably be transmitted to miniaturized card 20 for direct display on LCD 100 after processing or may be stored on removable storage 203 for later display.

Miniaturized card 20 also preferably includes the multiple mode capability. In the alternative embodiment shown in FIG. 2, the mode may be selected by the user by preferably actuating mode icon 204. Mode icon 204 is preferably a graphical icon displayed by display processor 102 (FIG. 1) as a part of the GUI. Using a finger, stylus 201, or other pointing object, the user may advantageously change the digital data displayed on LCD 100 to any other mode offered by miniaturized card 20.

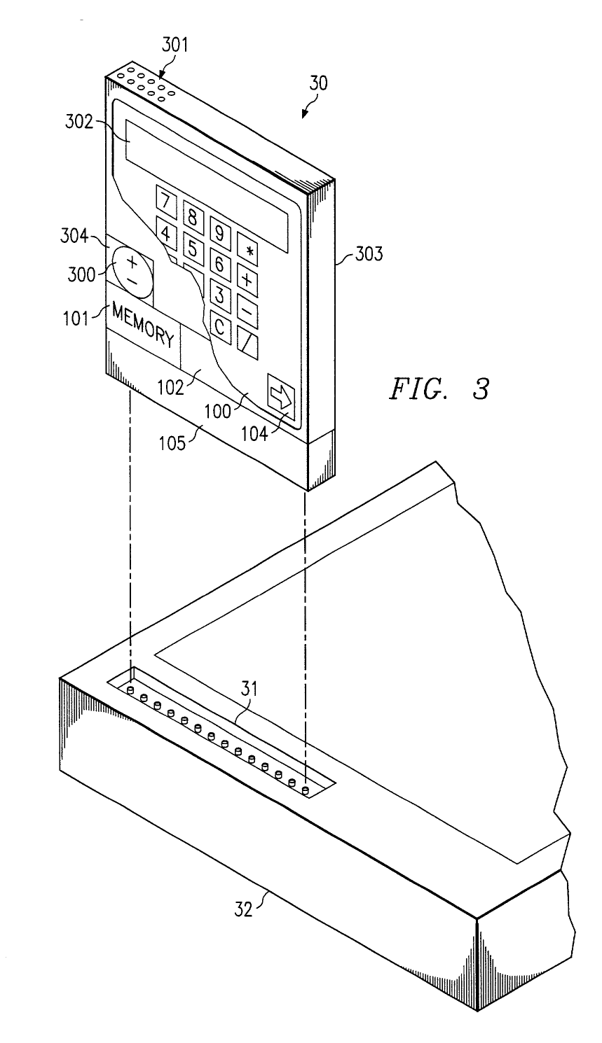

FIG. 3 illustrates a further alternative embodiment of the present invention. Photo card 30 also preferably comprises LCD 100, memory 101, display processor 102, and interface 105, as pictured in FIG. 1. Photo card 30 is depicted running in calculator mode 302. It should be noted that some of the digital data stored onto memory 101 may preferably comprise audio files. For example, a user could configure a file of digital data to preferably display a picture of a child on LCD 100, and also to preferably play an audio file of some verbal message from that child. Photo card 30 is preferably equipped with speaker 301 to provide the audio interface to users. As the audio file is selected by the user through the manipulation of one of picture selectors 104, display processor 102 preferably plays the corresponding audio over speaker 301. The photo card 30 may preferably comprise a miniaturized multimedia device that may preferably fit in a wallet.

Photo card 30 also contains removable battery 300 for providing the power to its components. Slot 304 is preferably provided to access removable battery 300 when it needs to be tested and/or changed.

In an application of the preferred embodiment shown in FIG. 3, photo card 30 may be directly interfaced with a compatible external device, such as scanner 32. Scanner 32 is preferably equipped with connection slot 31 that is compatible with the connection mechanism found in interface 105. Therefore, with scanner 32, a user may directly interface photo card 30 by preferably inserting interface 105 into connection slot 31. The electronic connection formed by the interfacing process allows digital information to be directly communicated between photo card 30 and scanner 32. Digital information representative of images from scanner 32 may preferably be directly displayed on LCD 100 of photo card 30. This capability preferably allows the user to view scans made by scanner 32 without necessity of a computer connected to scanner 32. The digital information from scanner 32 may also preferably be stored on memory 101 for later processing and display.

As photo card 30 is intended for storage in a wallet or other similar bag or receptacle, LCD 100 may be subjected to increased pressure or physical damage. For example, men typically store their wallets in a back pocket. Therefore, the act of sitting will generally place a large amount of pressure on the contents of the wallet. Photo card 30 preferably includes ruggedizing shield 303, which stiffens the entire assembly of photo card 30 and also protects LCD 100 from puncturing or from being overly damaged by excess pressure. The incorporation of ruggedizing shield 303 beneficially increases the durability of photo card 30 making it more appropriate for storage in a wallet.

FIG. 4 is a flow chart that lists the steps undertaken to implement a preferred embodiment of the present invention. In step 400, the digital data is preferably stored onto the miniaturized electronic card. Input is preferably received from a user in step 401 by reading the physical touches on the touch-sensitive color LCD screen. In step 402, the digital information is preferably processed according to the user's input. The processed digital information is then preferably displayed to the user in step 403.

Because the miniaturized electronic card may also interface with an external device, it may preferably also display information from such an external device. In such a case, the miniaturized electronic card preferably interfaces with at least one external device, in step 404. Any and all digital information is then preferably communicated between the miniaturized electronic card and the external device in step 405. When the digital information is received from the external device, the miniaturized electronic card preferably processes the information in step 402. After processing the digital information as received from the external device is preferably displayed to the user in step 403. Alternatively, the digital information as communicated from the external device may be preferably stored onto the miniaturized electronic card, in step 400.

It should be noted that the present invention is not limited to having only photo, calendar, and calculator modes of digital information. Any functionality that may be implemented onto a digital format may be executed and displayed on a preferred embodiment of the inventive device.

It should also be noted that the selectors, for pictures and modes, may comprise any combination of graphical buttons or physical buttons disposed on the miniaturized electronic card.

Additionally, with the advent of blue light emitting diodes (LEDs) a color LED screen would be possible that increased the durability of the screen without adding a ruggedizing substance. Alternatively, a flexible color LCD would also provide a higher level of protection for such a screen.

What is claimed is:

1. A wallet-sized electronic display card for presenting digital information to a user, said display card comprising:
a touch-sensitive color display covering a substantial portion of one face of said display card;
a memory;
a display processor;
a power source; and
a selector for controllably changing said digital information on said touch-sensitive color display.

2. The display card of claim 1 further comprising:
an interface connector for facilitating communication between said display card and an external device.

3. The display card of claim 2 wherein said interface connector comprises a transceiver for providing wireless communicating with said external device.

4. The display card of claim 2 further comprising a removable cradle having connection ports for said interface connector and at least one external device.

5. The display card of claim 4 wherein said cradle further recharges said power source.

6. The display card of claim 1 wherein said power source comprises:
a removable battery.

7. The display card of claim 1 wherein said digital information comprises at least one of:
a digital image;
an audio file;
a computational device; and
an electronic calendar.

8. The display card of claim 1 further comprising:
graphical user interface (GUI) code for facilitating manual communication with said user using said touch-sensitive color display.

9. The display card of claim 8 further comprising:
a stylus for assisting said user to enter information on said touch-sensitive color display.

10. The display card of claim 2 wherein said display card displays digital information generated from said external device.

11. The display card of claim 1 further comprising a speaker for audibly playing said digital information.

12. The display card of claim 1 further comprising:
a shield disposed about said display card for reinforcing said touch-sensitive color display.

13. The display card of claim 1 wherein said touch-sensitive color display comprises one of:
a liquid crystal display (LCD);
a light emitting diode (LED) display; and
a gas plasma display.

14. A method for displaying digital information on a miniaturized electronic card comprising the steps of:
storing said digital information onto said miniaturized electronic card;
receiving input from a user through manipulation of a touch-sensitive color display disposed on said miniaturized electronic card;
selectively processing said digital information responsive to said input received from said user;
displaying said selected digital information on said miniaturized electronic card;
receiving signals entered by said user through said touch-sensitive display to vary said information displayed; and
changing said digital information displayed on said miniaturized electronic card responsive to said signals entered by said user.

15. The method of claim 14 further comprising the steps of:
interfacing said miniaturized electronic card with at least one external device; and
communicating digital information between said miniaturized electronic card and said at least one external device.

16. The method of claim 15 further comprising the step of:
displaying external data on said touch-sensitive display generated by said at least one external device.

17. The method of claim 14 further comprising the steps of:
establishing wireless communication between said miniaturized electronic card and at least one external device; and
transceiving digital information between said miniaturized electronic card and said at least one external device.

18. The method of claim 14 wherein said touch-sensitive color display is ruggedized to increase a durability of said miniaturized electronic card.

19. An electronic photo card for displaying digital data comprising:
means for storing digital data on said photo card;
means for receiving input from a user through a touch-sensitive display;
means for rendering said digital data into an image;
means for displaying said image on said touch-sensitive color display;
means for changing a mode of digital data for display on said touch-sensitive color display; and
means for exchanging digital data with at least one external device.
